(19) United States
(12) Patent Application Publication
(10) Pub. No.: US 2016/0355206 A1
(43) Pub. Date: Dec. 8, 2016

(54) Transportation System

(71) Applicant: Karen Goss, Jacksonville, FL (US)

(72) Inventor: Karen Goss, Jacksonville, FL (US)

(21) Appl. No.: 14/731,694

(22) Filed: Jun. 5, 2015

(51) Int. Cl. B62B 7/06; B64D 11/00

(52) U.S. Cl. CPC B62B 7/06; B64D 11/003

(57) ABSTRACT

A transportation system includes a vehicle that has a storage bin. A stroller is structured to be positioned between a transporting position and a collapsed position. The stroller is positionable within the storage bin when the stroller is positioned in the collapsed position. The stroller may be used to transport a child when the stroller is positioned in the transporting position.

### BACKGROUND OF THE DISCLOSURE

### Field of the Disclosure

The disclosure relates to transportation devices and more particularly pertains to a new transportation device for allowing a stroller to fit within an overhead storage bin of a commercial airliner.

### SUMMARY OF THE DISCLOSURE

An embodiment of the disclosure meets the needs presented above by generally comprising a vehicle that has a storage bin. A stroller is structured to be positioned between a transporting position and a collapsed position. The stroller is positionable within the storage bin when the stroller is positioned in the collapsed position. The stroller may be used to transport a child when the stroller is positioned in the transporting position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a transportation system in a transporting position according to an embodiment of the disclosure.

FIG. 2 is a left side view of an embodiment of the disclosure.

FIG. 3 is a front view of an embodiment of the disclosure.

FIG. 4 is a right side exploded view of an embodiment of the disclosure.

FIG. 5 is a right side view of an embodiment of the disclosure in a collapsed position.

FIG. 6 is a perspective in-use view of an embodiment of the disclosure.

### DESCRIPTION OF THE PREFERRED EMBODIMENT

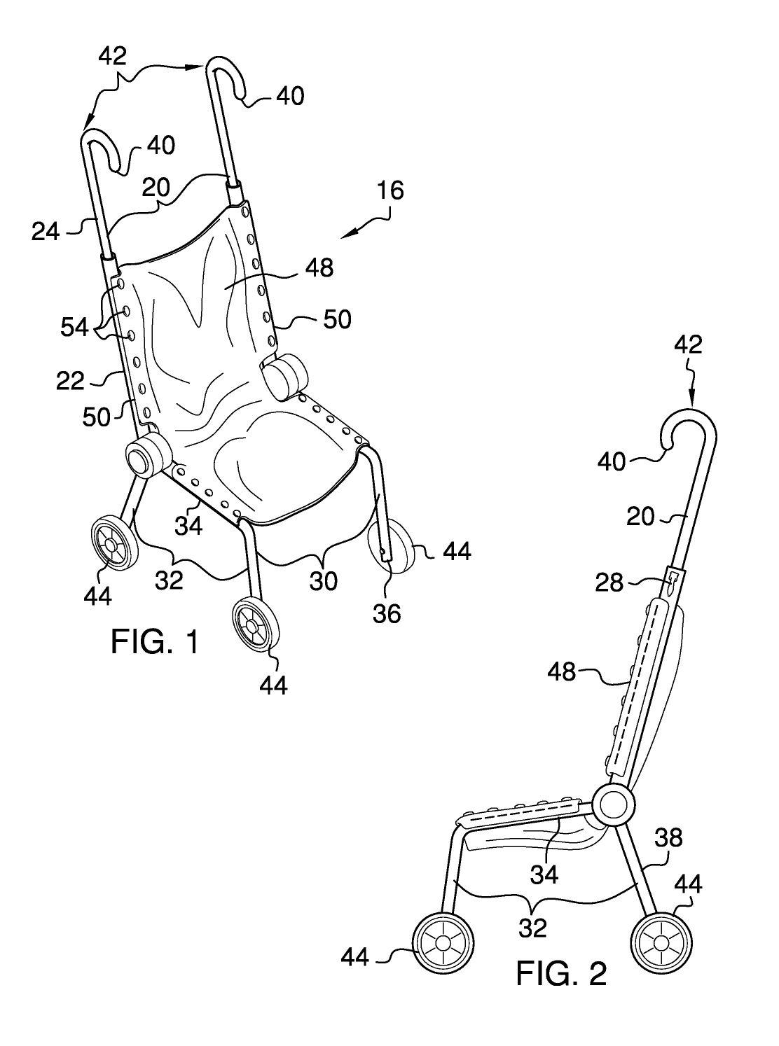

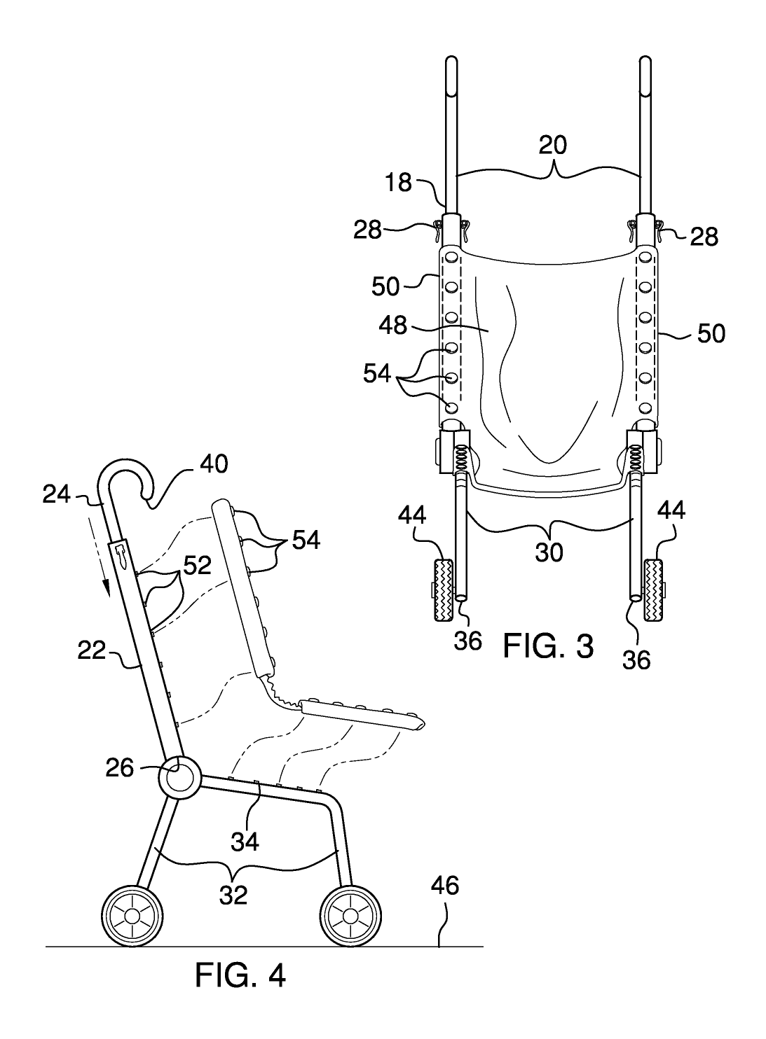

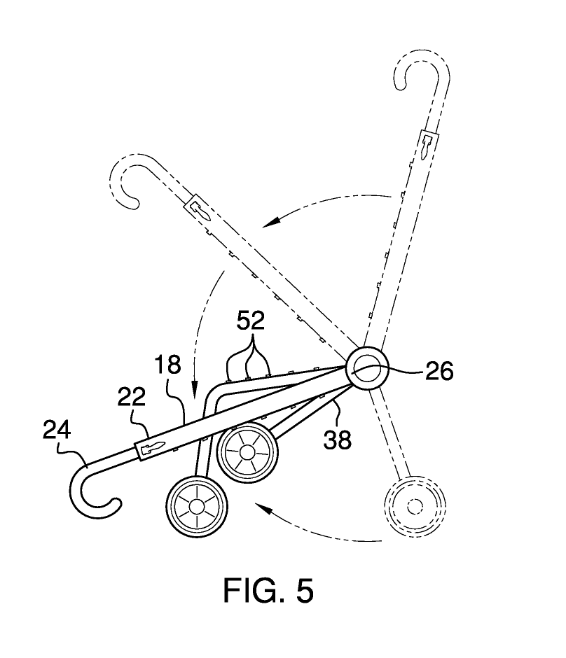

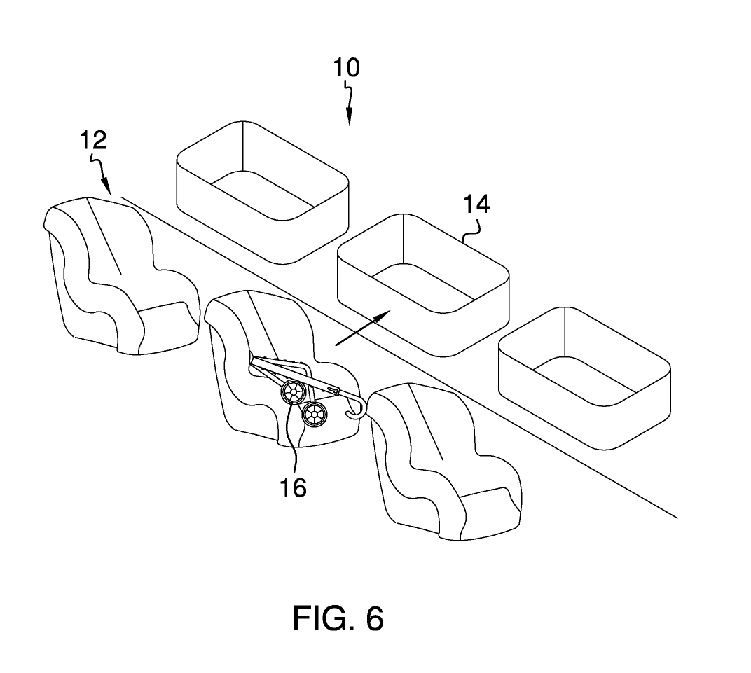

With reference now to the drawings, and in particular to FIGS. 1 through 6 thereof, a new transportation device embodying the principles and concepts of an embodiment of the disclosure and generally designated by the reference numeral 10 will be described.

As best illustrated in FIGS. 1 through 6, the transportation system 10 generally comprises a vehicle 12 that has a storage bin 14. The vehicle 12 may be a commercial air liner or the like and the storage bin 14 may be an overhead storage bin in the commercial air liner. A stroller 16 is provided and the stroller 16 is structured to be positioned between a transporting position and a collapsed position. The stroller 16 is positionable within the storage bin 14 when the stroller 16 is positioned in the collapsed position. The stroller 16 may transport a child when the stroller 16 is positioned in the transporting position.

The stroller 16 comprises a frame 18 and the frame 18 includes a pair of arms 20. Each of the arms 20 has a first portion 22 that is slidably coupled to a second portion 24 such that each of the arms 20 has a telescopically adjustable length. The first portion 22 of each of the arms 20 has a bottom end 26. A pair of locks 28 is provided and each of the locks 28 is coupled to the first portion 22 of an associated one of the arms 20. Each of the locks 28 is manipulated to engage the second portion 24 of the associated arm 20. Thus, each of the locks 28 retains the associated arm 20 at the selected telescopic length.

A pair of legs 30 is provided and each of the legs 30 has a pair of end sections 32 that is coupled to a central section 34. Each of the end sections 32 has a lower end 36 and the end sections 32 of each of an associated one of the legs 30 are spaced apart from each other such that each of the legs 30 has a U-shape. The pair of end sections 32 of each of the legs 30 includes a back one 38 of the end sections 32.

The back end section 38 of each of the legs 30 is hingedly coupled to the central section 34 of an associated one of the legs 30. The back end section 38 of each of the legs 30 is substantially coextensive with the central section 34 of the associated leg 30 when the stroller 16 is positioned in the collapsed position. The back end section 38 of each of the legs 30 extends downwardly from the central section 34 of the associated leg 30 when the stroller 16 is positioned in the transporting position.

The bottom end 26 of each of the first portions 22 is hingedly coupled to an associated one of the legs 30 and each of the arms 20 is positioned at an intersection of the back end section 38 and the central section 34 of the associated leg 30. Each of the arms 20 has a distal end 40 with respect to the associated leg 30 and each of the arms 20 is curved adjacent to the distal end 40 to define a handle 42 on each of the arms 20. Each of the arms 20 is coextensive with the central section 34 of the associated leg 30 when the stroller 16 is positioned in the collapsed position. Each of the arms 20 extends upwardly from the associated leg 30 when the stroller 16 is positioned in the transporting position. The frame 18 has a length that is less than approximately 22 inches and a width that is less than approximately 14 inches when the stroller 16 is positioned in the collapsed position. Thus, the stroller 16 may meet carry-on luggage size requirements of commercial airliners.

A plurality of wheels 44 is provided and each of the wheels 44 is rotatably coupled to an associated one of the lower ends 36 of the legs 30. Each of the wheels 44 may be positioned to abut a support surface 46 when the stroller 16 is positioned in the transporting position such that the stroller 16 may be rolled along the support surface 46. The support surface 46 may be ground.

A membrane 48 is provided that has a pair of lateral edges 50 and the membrane 48 is removably attached to the frame 18. The membrane 48 extends between the pair of arms 20 and the central section 34 of each of the legs 30 when the membrane 48 is attached to the frame 18. Thus, the membrane 48 may support the child when the stroller 16 is positioned in the transporting position. The membrane 48 is removed from the frame 18 when the stroller 16 is positioned in the collapsed position.

A plurality of first fasteners 52 is provided and each of the first fasteners 52 is positioned on and distributed along the first portion 22 of each of the arms 20 and the central section 34 of each of the legs 30. A plurality of second fasteners 54 is provided and each of the second fasteners 54 is attached to the membrane 48. The second fasteners 54 are distributed along an associated one of the lateral edges 50. Each of the second fasteners 54 engages an associated one of the first fasteners 52 when the membrane 48 is removably attached to the frame 18 such that the first fasteners 52 and the second fasteners 54 retain the membrane 48 on the frame 18. Each of the first fasteners 52 and the second fasteners 54 may comprise a snap or the like.

In use, the stroller 16 is positioned in the transporting position and the membrane 48 is coupled to the frame 18. The stroller 16 is utilized to transport the child. The membrane 48 is removed from the frame 18 and the stroller 16 is positioned in the collapsed position. Thus, the stroller 16 is positionable within the storage bin 14 in the vehicle 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A transportation system that breaks down to fit in a compact space, said system comprising:
a vehicle having a storage bin; and
a stroller being structured to be positioned between a transporting position and a collapsed position, said stroller being positionable within said storage bin when said stroller is positioned in said collapsed position, said stroller being configured to transport a child when said stroller is positioned in said transporting position.

2. The system according to claim 1, wherein said stroller comprises a frame including a pair of arms, each of said arms having a first portion slidably coupled to a second portion such that each of said arms has a telescopically adjustable length, said first portion of each of said arms having a bottom end.

3. The system according to claim 2, wherein said frame further includes a pair of legs, each of said legs having a pair of end sections being coupled to a central section, each of said end sections having a lower end, said end sections of each of an associated one of said legs being spaced apart from each other such that each of said legs has a U-shape.

4. The system according to claim 3, wherein said pair of end sections of each of said legs includes a back one of said end sections, said back end section of each of said legs being hingedly coupled to said central section of on associated one of said legs.

5. The system according to claim 4, wherein said back end section of each of said legs is substantially coextensive with said central section of said associated leg when said stroller is positioned in said collapsed position, said back end section of each of said legs extending downwardly from said central section of said associated leg when said stroller is positioned in said transporting position.

6. The system according to claim 3, wherein:
said pair of end sections include a back end section; and
said bottom end of each of said first portions is hingedly coupled to an associated one of said legs, each of said arms being positioned at an intersection of said back end section and said central section of said associated leg, each of said arms having a distal end with respect to said associated leg.

7. The system according to claim 6, wherein each of said arms is coextensive with said central section of said associated leg when said stroller is positioned in said collapsed position, each of said arms extending upwardly from said associated leg when said stroller is positioned in said transporting position.

8. The system according to claim 1, further comprising:
said stroller comprising a frame, said frame including a plurality of lower ends: and
a plurality of wheels, each of said wheels being rotatably coupled to an associated one of said lower ends, each of said wheels being configured to be positioned to abut a support surface when said stroller is positioned in said transporting position such that said stroller may be rolled along the support surface.

9. The system according to claim 1, further comprising:
said stroller comprising a frame, said frame including a pair of arms and a pair of legs, each of said legs including a central section; and
a membrane having a pair of lateral edges, said membrane being removably attached to said frame, said membrane extending between said pair of arms and said central section of each of said legs when said membrane is attached to said frame wherein said membrane is configured to support the child when said stroller is positioned in said transporting position, said membrane being removed from said frame when said stroller is positioned in said collapsed position.

10. The system according to claim 9, further comprising:
each of said arms including a first portion; and
a plurality of first fasteners, said first fasteners being positioned along said first portion of each of said arms and said central section of each of said legs.

11. The system according to claim 10, further comprising a plurality of second fasteners, each of said second fasteners being attached to said membrane, said second fasteners being distributed along an associated one of said lateral edges, each of said second fasteners engaging an associated one of said first fasteners when said membrane is removably attached to said frame wherein said first fasteners and said second fasteners retain said membrane on said frame.

12. A transportation system that breaks down to fit in a compact space, said system comprising:
a vehicle having a storage bin; and
a stroller being structured to be positioned between a transporting position and a collapsed position, said stroller being positionable within said storage bin when said stroller is positioned in said collapsed position, said stroller being configured to transport a child when said stroller is positioned in said transporting position, said stroller comprising:
a frame including:
a pair of arms, each of said arms having a first portion slidably coupled to a second portion such that each of said arms has a telescopically adjustable length, said first portion of each of said arms having a bottom end, and
a pair of legs, each of said legs having a pair of end sections being coupled to a central section, each of said end sections having a lower end, said end sections of each of an associated one of said legs being spaced apart from each other such that each of said legs has a U-shape, said pair of end sections of each of said legs including a back one of said end sections, said back end section of each of said legs being hingedly coupled to said central section of on associated one of said legs, said back end section of each of said legs being substantially coextensive with said central section of said associated leg when said stroller is positioned in said collapsed position, said back end section of each of said legs extending downwardly from said central section of said associated leg when said stroller is positioned in said transporting position,
said bottom end of each of said first portions being hingedly coupled to an associated one of said legs, each of said arms being positioned at an intersection of said back end section and said central section of said associated leg, each of said arms having a distal end with respect to said associated leg, each of said arms being coextensive with said central section of said associated leg when said stroller is positioned in said collapsed position, each of said arms extending upwardly from said associated leg when said stroller is positioned in said transporting position,
a plurality of wheels, each of said wheels being rotatably coupled to an associated one of said lower ends, each of said wheels being configured to be positioned to abut a support surface when said stroller is positioned in said transporting position such that said stroller may be rolled along the support surface,
a membrane having a pair of lateral edges, said membrane being removably attached to said frame, said membrane extending between said pair of arms and said central section of each of said legs when said membrane is attached to said frame wherein said membrane is configured to support the child when said stroller is positioned in said transporting position, said membrane being removed from said frame when said stroller is positioned in said collapsed position,
a plurality of first fasteners, said first fasteners being positioned along said first portion of each of said arms and said central section of each of said legs, and
a plurality of second fasteners, each of said second fasteners being attached to said membrane, said second fasteners being distributed along an associated one of said lateral edges, each of said second fasteners engaging an associated one of said first fasteners when said membrane is removably attached to said frame wherein said first fasteners and said second fasteners retain said membrane on said frame.
